(19) United States
(12) Patent Application Publication
(10) Pub. No.: US 2017/0199576 A1
(43) Pub. Date: Jul. 13, 2017

(54) Interactive Mirror

(71) Applicant: ICONMOBILE GMBH, Berlin (DE)

(72) Inventor: Adrian Schmitz-Le Hanne, Berlin (DE)

(21) Appl. No.: 15/324,797

(22) PCT Filed: Jul. 6, 2015
(86) PCT No.: PCT/EP2015/065379

§ 371 Date: Jan. 9, 2017

(30) Foreign Application Priority Data
Jul. 10, 2014 (DE) 10 2014 010 352.8

(51) Int. Cl. G06F 3/01; G06F 3/147; G02B 5/08

(52) U.S. Cl. CPC G06F 3/017; G02B 5/08; G06F 3/147

(57) ABSTRACT

The present invention relates to an interactive mirror comprising a reflective mirror surface, at least one display integrated into the mirror surface, at least one active infrared sensor integrated into the mirror, and a processor adapted to determine a person's motions and/or gestures made in front of the mirror on the basis of the data captured by the at least one sensor.

### FIELD OF THE INVENTION

The present invention relates to an interactive mirror that can be controlled by means of motions and/or gestures.

### BACKGROUND

We spend a large part of our lifetime in front of mirrors, for example, in front of a bathroom mirror during toothbrushing or shaving. Since these activities do not require our attention to a large extent, it would be desirable to use this time simultaneously for other things, such as, for example, more efficiently operating appliances, reading news, and the like. It is known, for example, from US 2002/0080494 A1 to show additional information on a mirror. Direct interaction with the mirror by means of a touch screen is also known from this document.

However, the use of a touch screen in the bathroom actually does not make much sense because touching the mirror in combination with the usual humidity in the bathroom leaves unaesthetic marks. Therefore, WO 2005/031552 A2 suggests controlling a display integrated into a mirror by means of gestures that are monitored by a plurality of cameras. However, especially when such an interactive mirror is intended to communicate with further external appliances and in particular the Internet, many users will shy away from being recorded by cameras when, as the case may be, they are undressed.

Therefore, a problem underlying the present invention consists in the provision of an improved interactive mirror which, inter alia, takes into account the aforementioned disadvantages. This problem is solved by an interactive mirror according to claim 1. Preferred features of the interactive mirror according to the present invention are described in the dependent claims.

### SUMMARY

Accordingly, the present invention relates to an interactive mirror comprising an at least partly reflecting mirror surface and at least one display integrated into the mirror surface. The mirror according to the present invention further comprises an active infrared sensor which is integrated into the mirror or attached to the mirror. Furthermore, the mirror comprises a processor which, on the basis of the data captured by the at least one sensor, is adapted to determine a person's motions and/or gestures made in front of the mirror. In other words, a component of the active infrared sensor transmits radiation in the infrared range that is reflected at a person in front of the mirror. The reflected infrared rays are received by a component of the active infrared sensor and the received data are evaluated by the processor. On the basis of the data captured by the at least one sensor, the processor is able to determine motions and/or gestures made by the person in front of the mirror. The transmitter and receiver components of the active infrared sensor can be integrated into one individual sensor or consist of separate components which may be attached to the mirror at a distance from one another.

The at least one display is integrated into the mirror surface such that the display area of the mirror surface can indicate information when the display is switched on while it is configured to be reflective such that a person in front of the mirror cannot see any difference in his/her mirror image between the display area and the remaining mirror surface when the display is switched off. To this end, the at least partly reflecting mirror surface is provided with a luminous transmittance of preferably at least 10%, more preferably at least 15% and most preferably of at least 20%. Preferably, the areas of the mirror surface into which no display is integrated are clad at the rear side of the mirror with a black foil which enhances the contrast. The switched off, black display and the black foil preferably have essentially the same optical properties in the visible spectrum in order to ensure that a homogeneous mirror image is created.

Preferably, the interactive mirror according to the present invention comprises at least two active infrared sensors which are preferably arranged at or near two opposite borders of the mirror surface or the mirror. Preferably, the mirror according to the present invention comprises one active infrared sensor each at the two lateral mirror borders. This enables that, e.g., gestures of the right hand and the left hand can be especially well determined and distinguished from each other. Even though the use of an active infrared sensor is particularly preferred, the present invention is not limited to such sensors. In fact, instead of the active infrared sensor, it is also possible to use a passive infrared sensor only measuring infrared radiation emitted by a person or to provide an ultrasound sensor. Hence, all features described in connection with the present invention can also be used in an interactive mirror comprising a passive infrared sensor integrated into the mirror or an ultrasound sensor integrated in the mirror.

The processor is preferably adapted to adjust the brightness of the integrated display to the ambient brightness. To this end, the mirror according to the present invention preferably comprises a brightness sensor such as, e.g., a photodiode. Additionally or alternatively, such a brightness sensor can serve the purpose of activating the mirror, i.e., converting the mirror from a merely reflective condition (commercially available mirror) into an interactive mirror adapted to determine motions and/or gestures and/or to show information on the display. Thus, the mirror according to the present invention can be activated, for example, in that light is switched on in the bathroom.

Preferably, the interactive mirror of the present invention is adapted to communicate wirelessly or via a cable connection with one or more external electronic devices. These electronic devices may be, for example, servers, PCs, tablet computers, smart phones or an Internet access. Most preferably, the external electronic devices are, for example, electric shavers, electric toothbrushes, hairdryers, and the like.

Preferably, the interactive mirror is adapted to recognize an external electronic device if it is brought into the vicinity of the mirror and/or switched on in the vicinity of the mirror. To this end, the interactive mirror can comprise one or a combination of the following interfaces: near-field communication, Bluetooth transmitter and/or receiver, WiFi, TP Ethernet, 433/866 MHz network, ZigBee network, RFID sensor, infrared transmitter and/or receiver.

Preferably, the interactive mirror is adapted to perform one or more of the following actions on the basis of the data received from an external electronic device: change from an inactive mode to an active mode, change from an active mode to an inactive mode, start and/or termination of an application related to the external electronic device, indication of device-specific information on the display, indication of instructions on the display, indication of usage data associated with the previous and/or recommended way of use of the external electronic device, control of a further external electronic device, transfer of device-specific information and/or usage data to a further external electronic device.

For example, a digitally networked toothbrush can show a control and information area on the display of the interactive mirror in order to inform the user about the current and preceding uses of the toothbrush and/or in order to indicate details about the dental care process currently taking place. The mirror could be activated or inactivated, for example, in that, e.g., this toothbrush is shortly brought into the vicinity of the mirror or a predefined zone at the mirror glass. A further example is the combination of the mirror according to the present invention with a home automation system so that, for example, pieces of information such as the opening of the entry door or the garage or even an alarm condition of a smoke or breakage-of-glass detector are shown as information on the mirror.

It is further preferred that the interactive mirror is adapted to control an external electronic device, preferably two or more electronic devices at the same time. Preferably, the control can be controlled via motions and/or gestures made in front of the mirror. For example, the control of the bathtub water supply with respect to the water temperature and the time of the filling could be controlled via the mirror and the subsequent signalization to the user via a further device once the bathtub has been filled. The entry of dates into the calendar on, e.g., the smart phone via gestures recognized by the mirror would be a further example.

The interactive mirror preferably further comprises a microphone. This enables, for example, an additional acoustic control. In this way, it would be possible, for example, to dictate e-mails or calendar entries. Moreover, the processor can be adapted to infer a currently active external electronic device from the noise recorded by the microphone in that the received noise is compared to the stored operating noise of the external electronic device. This is because electronic toothbrushes, hairdryers and electric shavers respectively generate a specific noise, which could be recognized by the mirror according to the present invention by means of the microphone.

Preferably, the processor is adapted to show specific retrofittable applications (“apps” and “widgets”) on the display, for example, by means of a network connection. These applications could comprise, for example, information generally or specifically relevant to the user such as, e.g., the weather, traffic information, news, etc., but also contents of social networks such as Facebook and Twitter. Alternatively or additionally, such applications can be preinstalled in the processor or a memory unit.

The mirror according to the present invention is preferably adapted to integrate or show information indicated on the display into or in the mirror image of a person in front of the mirror. In this connection, the application is preferably adaptively adjusted to the person's current position. For example, predefined shaving patterns could be superimposed over the person's mirror image when a compatible electric shaver is used.

The processor of the mirror according to the present invention is preferably able to distinguish intended interactions of the person in front of the mirror from general motions in order to avoid a faulty operation by the user. This can be achieved, inter alia, in that specific gestures are recognized as control gestures only if they occur in combination with a specific external electronic device.

It is further preferred that the mirror according to the present invention can self-actingly show messages/information and/or trigger an alarm acoustically and/or via background lighting also in the absence of a person in front of the mirror or in the room and also in the deactivated state. This can make sense, for example, in the case of inbound high-priority messages (smoke detector, severe weather warning, etc.).

Preferably, the processor of the mirror according to the present invention is adapted to identify a person in front of the mirror on the basis of the data captured by the at least one sensor. This can be achieved, for example, in that the processor concludes the size of the person in front of the mirror on the basis of the data captured by the at least one sensor. Additionally or alternatively, the processor can be adapted to recognize specific motion patterns typical of a specific person. The use of personal objects (toothbrush, RFID wristband, smart watch, etc.) can represent a further possibility of identification. The processor is further preferably adapted to show personalized data on the display on the basis of the identification.

Preferably, the at least one display comprises two displays arranged next to each other and/or two separate display arrays arranged next to each other, which can be used by the user depending on preference (e.g., for left-handers or right-handers). Preferably, the two displays or display arrays arranged next to each other can be used by two persons in front of the mirror at the same time. On the basis of the data captured by the at least one sensor, the processor is preferably adapted to determine motions and/or gestures made by two persons in front of the mirror at the same time and to assign them to the respective persons.

The mirror according to the present invention further permits to the user to define specific gestures and/or gesture combinations and to link specific control commands therewith so that, whenever the thus defined gesture or gesture combination is made, the processor of the mirror performs the action linked therewith, i.e., for example, shows a specific content on the display, starts communication with a specific external electronic device, and the like. Such gestures or gesture combinations can comprise any motion of the body or rather of one or more parts of the body, such as an arm or a hand, for example, horizontal and/or vertical wiping motions, flapping motions of the fingers, pointing motions using one or more fingers, opening and/or closing the hand, lifting or lowering an arm, nodding the head and/or shaking the head, and the like.

The present invention further relates to a method comprising the following steps: providing an interactive mirror comprising a display, a sensor and a processor, preferably an interactive mirror as described above; making a motion and/or gesture in front of the mirror, wherein the motion and/or gesture can be made by one or more persons at the same time; capturing the motion and/or gesture made by the at least one sensor; and evaluating the captured data by the processor in order to identify the motion and/or gesture made in front of the mirror.

On the basis of the identified motion and/or gesture, an action is preferably triggered by the processor and/or performed by it. Preferably, the action is one or a combination of the following actions: change of the mirror from an inactive mode to an active mode, change of the mirror from an active mode to an inactive mode, start and/or termination of an application related to the external electronic device, indication of device-specific information on the display, indication of instructions on the display, indication of usage data associated with the previous and/or recommended way of use of an external electronic device, indication of general and/or user-specific information such as, e.g., news, e-mails, weather, Twitter, Facebook, etc.

Preferably, the method according to the present invention further comprises the step of wireless communication of the interactive mirror with one or more external electronic devices and/or wireless control of one or more external electronic devices. Preferably, the method according to the present invention further comprises the step of wireless control of one or more external electronic device by means of a motion and/or gesture made in front of the mirror.

Preferably, the method according to the present invention further comprises the step of configuration of the interactive mirror, wherein a user links one or more motions and/or gestures with specific actions which the processor of the mirror is to perform or trigger when the user makes the motion and/or gesture. To this end, the motion or gesture is made once or several times in front of the mirror until the mirror signals that the motion and/or gesture was recognized with sufficient accuracy and stored. The gesture and/or motion is then linked with a specific action such as, e.g., “indicating news”, so that, for example, whenever the user clenches a hand into a first and re-opens it in front of the mirror, the current news are indicated on the display of the mirror.

The method according to the present invention preferably further comprises the step of identification of a person in front of the mirror on the basis of the data captured by the at least one sensor. This identification can be made, for example, by means of the size of the person in front of the mirror. Additionally or alternatively, other body features and/or typical motion behaviors can be taken as a basis in order to identify the person. A further identification possibility can be the use of personal objects (toothbrush, RFID wristband, smart watch, etc.). If the interactive mirror comprises a microphone, the identification can additionally or alternatively also take place via the person's voice. Furthermore, the method according to the present invention preferably comprises the step of indicating personalized data on the display on the basis of the person's identification. To this end, profiles and requests of individual users (user profiles) which can influence the output of data (personalization) are preferably stored in the main software of the processor. During the identification, data provided by one or more sensors are preferably interpreted by the main software of the processor in order to distinguish the possible users from one another, for example, according to gesture, size (infrared), silhouette (camera) and/or voice (speech input).

It should be understood that all preferred features described in connection with the interactive mirror according to the present invention are also preferred features of the method according to the present invention and vice versa.

The mirror according to the present invention is an extremely versatile device which affords complex interaction possibilities both with the mirror itself and with further external electronic devices without the use of a keyboard or a touch screen being required. The user's gestures and/or motions are determined in a confidential way since no camera recordings of the user are necessary for the identification of the gestures and/or motions. Even though preferred features of the mirror according to the present invention are primarily described in connection with a mirror in a bathroom, it should be understood that the mirror according to the present invention can also be applied outside the bathroom, for example, in the corridor, in hotel rooms, in fitness rooms, and the like.

### BRIEF DESCRIPTION OF THE DRAWINGS

In the following, preferred embodiments of the invention are described in more detail with reference to the Figures, in which:

FIG. 1 shows a schematic top view of a preferred embodiment of an interactive mirror according to the present invention;

FIG. 2a shows a schematic top view in a partial section of a preferred embodiment of an interactive mirror according to the present invention;

FIG. 2b shows a lateral partial-sectional view of the embodiment of FIG. 2a; and FIG. 2c shows a partial-sectional top view of the embodiment of FIG. 2a.

### DETAILED DESCRIPTION

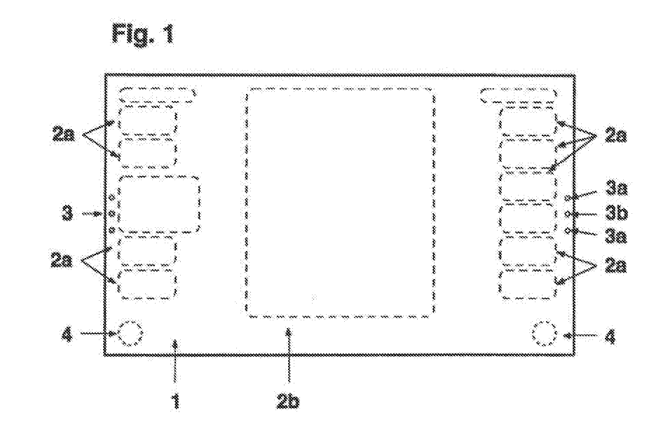

FIG. 1 schematically depicts a preferred embodiment of the interactive mirror according to the present invention. The interactive mirror comprises an at least partly reflective mirror surface 1, a plurality of displays 2a and 2b integrated into the mirror surface, two active infrared sensors 3 integrated into the mirror, and a non-depicted processor which, on the basis of the data captured by the two sensors 3, is adapted to determine and identify a person's motions and/or gestures made in front of the mirror. Furthermore, the interactive mirror according to FIG. 1 comprises two optional microphones 4, which can provide audio information that, on the one hand, can be evaluated according to the noise itself (for example, the operating noise of an electric toothbrush or shaver), but, on the other hand, can also be recorded and evaluated as speech, in order to enable, for example, a speech input.

A possible implementation of the processor is an 8-bit or 32-bit microprocessor for embedded solutions, on which a software written, for example, in the programming language C reads the sensors 3, which are connected, e.g., via a serial data bus like I2C, in an interrupt-based manner. The transferred data are then checked by the microprocessor with respect to cogency and gesture, and converted into a gesture code which is used by the control software of the mirror for further applications. The sensor Halios E909.05 of Mechaless Systems GmbH is an example of an active infrared sensor adapted to determine gestures according to the present invention. This sensor then provides gesture codes to the main system software of the processor. The documentation of the E909.05 sensor documents how these gestures are recognized in detail.

For the purpose of identification and communication, the processor is preferably provided with corresponding subsystems (Bluetooth, WiFi, etc.). During the connection establishment with these subsystems, the processor performs an identification of the device (e.g. toothbrush via Bluetooth) by means of the device code and triggers a respective function in the main program of the mirror.

The interactive mirror is preferably adapted to perform one or more of the following actions on the basis of the data received from an external electronic device: change from an inactive mode to an active mode, change from an active mode to an inactive mode, start and/or termination of an application related to the external electronic device, indication of device-specific information on the display, indication of instructions on the display, indication of usage data associated with the previous and/or recommended way of use of the external electronic device, control of a further external electronic device, transfer of device-specific information and/or usage data to a further external electronic device. The functions required to this end are triggered by main software of the mirror processor, for example, via local control processors as well as via network data. The main software preferably likewise controls the visual representation on the display and evaluates data from the sensors 3 or further devices (not shown).

In the depicted preferred embodiment, a plurality of display arrays 2a having different shapes and sizes are provided in the two lateral border areas of the mirror surface 1. Preferably, these display arrays are no separate displays. Rather, the two border areas of the mirror surface 1 comprise a large-surface display, which, e.g., is rectangular and by means of which, controlled by the processor, one or more display arrays can be shown as and when required. Individual display arrays can be provided for different contents. It is, for example, possible to show news, traffic information, weather information, e-mails, Facebook, Twitter, calendar entries, and the like in separate display arrays as and when required. The arrangement, shape and size of the display arrays assigned to the different contents can preferably be adjusted and/or programmed by the user.

The provision of two displays in the two lateral border areas of the mirror surface 1 is particularly preferred because it permits to show information on the left and/or right side of the mirror surface 1 as required (e.g., in the case of left-handers and right-handers). Furthermore, the two separate displays on the left and right sides could be used at the same time by two persons in front of the mirror, wherein one display is assigned to each person. Preferably, each of the two lateral displays occupies a width of less than 30%, more preferably of less than 25% and most preferably of less than 20% of the width of the mirror surface 1. Preferably, a further display 2b, which is centrically arranged and preferably adapted to show information in the mirror image of the user, is additionally provided. For example, predefined shaving patterns could be shown in the person's mirror image when a compatible electric shaver is used. For this function, an analysis of the position of a person is preferably retrieved from the built-in sensors and used for the respective position of the image memory which corresponds to the physical position of the representation of the person. The main software is thus able to integrate and show information in the right place even in the case of motion.

This central display 2b preferably occupies at least 40%, more preferably at least 50% and most preferably at least 60% of the width of the mirror surface 1. Instead of two laterally arranged displays and one central display 2b, it is also possible to provide one single large-surface display, which shows information in one or both border areas as and when required and superimposes information over the user's mirror image in the central area.

The two active infrared sensors 3 integrated into the mirror are preferably arranged at the two lateral borders of the mirror surface 1, as depicted in FIG. 1. Most preferably, the two sensors 3 are arranged approximately centrically with respect to the mirror width, as likewise depicted in FIG. 1. However, the two sensors 3 can also be displaced towards the top or the bottom and/or arranged at the top and/or bottom border of the mirror surface 1. It is also possible to provide more than two sensors 3, for example, four or six sensors. The arrangement of at least two sensors 3 at least at both lateral borders of the mirror surface 1 permits, for example, to distinguish especially well between gestures of the right hand and the left hand and/or between two persons in front of the mirror. Each active infrared sensor 3 preferably consists of two external transmitters 3a of radiation in the infrared range and one receiver 3b arranged centrally, preferably centrically, for reflected radiation in the infrared range. However, it is also possible according to the invention that other sensor geometries are used. For example, it is also possible that three or four infrared LEDs in the form of a triangle, rectangle or square are arranged around one or more infrared photodiodes.

The two microphones 4 are preferably likewise arranged at the two lateral borders of the mirror surface 1, as illustrated in FIG. 1. However, they do not have to be arranged at the lower border of the mirror surface 1 but can also be provided further above.

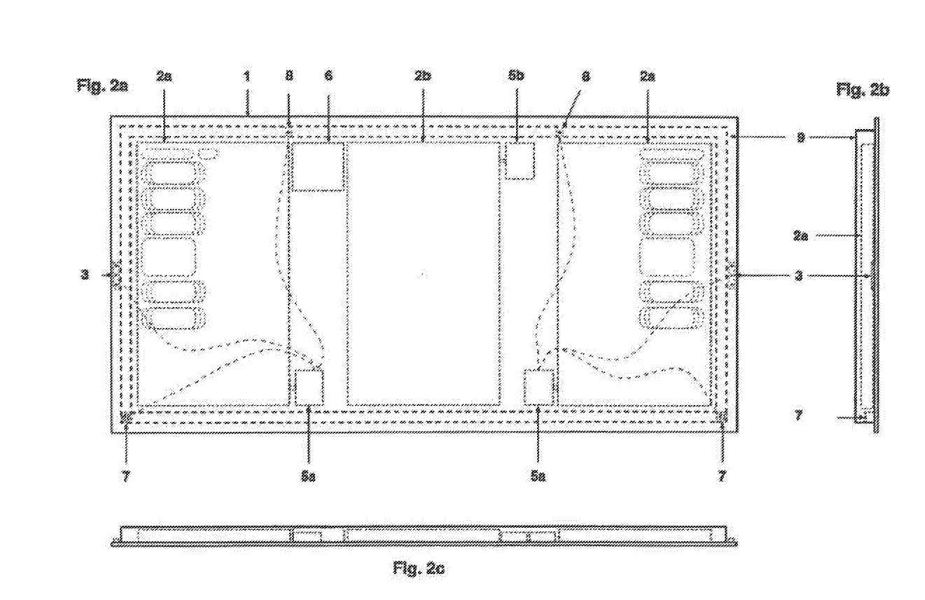

FIGS. 2a to 2c illustrate a further preferred embodiment of the interactive mirror according to the invention. The mirror comprises a mirror surface 1 being mounted onto a frame 9 and preferably comprising mirror glass with a reflective coating that has a luminous transmittance of at least 10%, preferably of at least 15% and most preferably of at least 20%. Preferably, the rear side of the coated mirror glass is clad with a black foil which enhances the contrast. This foil has preferably cutouts for the display elements 2a and 2b in order that data and information can be shown on the mirror image.

In the illustrated preferred embodiment, two displays arranged at the lateral mirror borders and one display 2b arranged centrally centrically are provided. Even though the three displays 2a and 2b are illustrated in approximately the same size and shape, the size and shape of the two lateral displays 2a, on the one hand, and of the centric display 2b, on the other hand, can differ from each other. Preferably, the centric display 2b occupies at least 40%, more preferably at least 50% and most preferably at least 60% of the width of the mirror surface 1. As already described above in connection with FIG. 1, different display arrays with different information are preferably shown on the two lateral displays 2a, whereas information about the user's mirror image is preferably shown on the central display 2b. However, it is also possible to provide display arrays for showing information in the central display 2b while using the two lateral displays 2a for showing information about the mirror images of two persons in front of the mirror.

In the illustrated preferred embodiment, each of the three displays 2a and 2b is equipped with its own processor 5a and 5b. Alternatively, one single processor can be provided for all three displays. The displays and processors are supplied with power via a power supply unit 6. Two active infrared sensors 3 are located at the two lateral borders of the mirror surface 1. Furthermore, two near-field sensors 7 and two sensors 8 are provided which are adapted to detect whether a person is in front of the mirror. These near-field sensors can be implemented, for example, on the basis of active or passive infrared technology (PIR), laser tracking, light section measurement or ultrasound. In the illustrated preferred embodiment, an active infrared sensor 3 and such a sensor 8 are connected to a processor 5a (indicated by the broken lines) so that each of a left and/or a right unit is formed by two sensors 3 and 8, a display 2a and a processor 5a. However, it is also possible that all sensors and displays are connected to one single processor. Each of the near-field sensors 7 is connected to a processor 5a.

The displays 2a and 2b can be, for instance, TFT display elements connected to the processors via appropriate connections (e.g., HDMI, LVDS, or the like) in order to enable a representation as lossless as possible. The control of the displays and/or display elements including the power supply and optional background lighting is performed via integrated control elements. A controlling computer can take care of one or more screens. The core tasks of the controlling computer or computers are receipt and transmission of data, information and control sequences via a network standard such as Ethernet, WiFi, Bluetooth, ZigBee, or the like, the preparation and rendering of the data and operating elements on the display units and/or displays mounted behind the mirror glass and the exploitation and processing of the data of the installed sensors (proximity sensor, gesture sensor, NFC reader, brightness sensor). The controlling computer can consist of an appropriate embedded system which can be equipped with an operating system such as, e.g., Linux and permits the connection of one or more display units. Sensors are preferably directly embedded via connections such as USB or Bluetooth, but can also be integrated via a specific electronics extension capturing the sensor information. The processing power and storage performance of the embedded system must be sufficient to enable also complex representations during concurrent network and sensor operations.

Preferably, the interactive mirror is adapted to control an external electronic device, preferably two or more electronic devices at the same time. The control is preferably performed by the main operating software, which can control external electronic devices via local network components/subsystems as well as via the standard network interfaces (WiFi, Ethernet, Bluetooth, etc.). Rules and dependencies for the control can be implemented in a firmly anchored way in the main operating software or alternatively also subsequently loaded as a set of rules via a network connection.

The active infrared sensors 3 are preferably integrated centrically in the left and right borders of the mirror surface 1. On the basis of an infrared field established by the transmitter portions 3a (cf. FIG. 1) of the sensor in the area in front of each display area, gestures in a 2D or 3D field can be recognized in that they generate specific reflections of the infrared field signal. These reflections are captured by infrared sensors 3b (cf. FIG. 1) located directly above and below the infrared transmitter 3a. The reflection causer (e.g., a hand making a gesture) can be determined in real time with respect to its position and depth by means of a signal analysis of the reflection information of the two sensors. This information is passed to the controlling computer via, for example, a serial bus and said controlling computer determines the current gesture on the basis of the position data and performs the rule stored for the interaction (e.g., displaying the weather data). The sensor Halios E909.05 of Mechaless Systems GmbH is an example of an active infrared sensor adapted to determine gestures according to the present invention.

When two or more displays are provided (cf. FIG. 2a), they can preferably be used by two persons in front of the mirror at the same time. This is technically enabled, for example, in that the main software is programmed to process more than one user context at the same time (parallel processing/threads). Alternatively, two systems independent from each other can be installed. In this case, the processor is preferably also adapted to determine motions and/or gestures made by two persons in front of the mirror at the same time on the basis of the data captured by the at least one sensor and to assign them to the respective persons. The evaluation of these sensor signals is preferably made by a three-dimensional analysis of the generated motions/gestures which can take place on the basis of coordinates in the case of an infrared sensor or alternatively by an image analysis in the case of a camera picture.

The frame 9 can be, for example, an aluminum frame made of, for example, L sections. The mirror glass can be attached to the frame 9, for example, by means of a specific adhesive film. The frame 9 guarantees a certain minimum distance (for example, 4-6 cm) from the wall in order that components and screens can be mounted behind the mirror glass. Furthermore, the frame 9 preferably serves as a mounting surface for an indirect mirror illumination (not shown) and as a cooling member for light and electronic elements. Aluminum is in particular suitable for the latter. Preferably one or more LED strips are adhered to the frame 9 so as to emit their light to the rear for the purpose of indirect background lighting.

It should be understood that the arrangement of the individual components, the relative size and shape of the individual components, and the like are only meant to be examples. Instead of three displays 2a and 2b, only one or two displays can be provided. The sensors 3, 7, and 8 can be differently arranged and there can also be more than two sensors of one type. In addition to the depicted sensors, microphones, further interfaces and input elements can be provided.

1-13. (canceled)

14. An interactive mirror comprising a reflective mirror surface, at least one display integrated into the mirror surface, at least one active infrared sensor integrated into the mirror, and a processor adapted to determine a person's motions and/or gestures made in front of the mirror on the basis of the data captured by the at least one sensor.

15. The interactive mirror according to claim 14, wherein the interactive mirror is adapted to communicate wirelessly or via a cable connection with one or more external electronic devices.

16. The interactive mirror according to claim 15, wherein the interactive mirror is adapted to recognize an external electronic device if it is brought into the vicinity of the mirror and/or switched on in the vicinity of the mirror.

17. The interactive mirror according to claim 15, wherein the interactive mirror comprises one or a combination of the following interfaces: near-field communication, Bluetooth transmitter and/or receiver, WiFi, TP Ethernet, 433/866 MHz network, ZigBee network, RFID sensor, infrared transmitter and/or receiver.

18. The interactive mirror according to claim 15, wherein the interactive mirror is adapted to perform one or more of the following actions on the basis of the data received from an external electronic device: change from an inactive mode to an active mode, change from an active mode to an inactive mode, start and/or termination of an application related to the external electronic device, indication of device-specific information on the display, indication of instructions on the display, indication of usage data associated with the previous and/or recommended way of use of the external electronic device, control of a further external electronic device, transfer of device-specific information and/or usage data to a further external electronic device.

19. The interactive mirror according to claim 15, wherein the interactive mirror is adapted to control an external electronic device.

20. The interactive mirror according to claim 19, wherein the interactive mirror is adapted to control two or more electronic devices at the same time.

21. The interactive mirror according to claim 19, wherein the control can be controlled via motions and/or gestures made in front of the mirror.

22. The interactive mirror according to claim 14, wherein the interactive mirror further comprises a microphone.

23. The interactive mirror according to claim 14, wherein the processor is adapted to identify a person in front of the mirror on the basis of the data captured by the at least one sensor.

24. The interactive mirror according to claim 23, wherein the processor is adapted to show personalized data on the display on the basis of the identification.

25. The interactive mirror according to claim 14, wherein the at least one display comprises two displays arranged next to each other.

26. The interactive mirror according to claim 25, wherein the two displays can be used by two persons in front of the mirror at the same time.

27. The interactive mirror according to claim 25, wherein the processor is adapted to determine motions and/or gestures made by two persons in front of the mirror at the same time and to assign them to the respective persons on the basis of the data captured by the at least one sensor.

28. The interactive mirror according to claim 14, wherein the processor is adapted to integrate or show information indicated on the display into or in the mirror image of a person in front of the mirror.

29. A method for controlling an interactive mirror, comprising the following steps:
(a) providing an interactive mirror comprising at least one display, at least one active infrared sensor and at least one processor;
(b) making a motion and/or gesture in front of the mirror;
(c) capturing the motion and/or gesture made by the at least one sensor; and
(d) evaluating the data captured by the at least one sensor by the processor in order to determine the motion and/or gesture made in front of the mirror.

30. The method according to claim 29, wherein the interactive mirror is adapted to communicate wirelessly or via a cable connection with one or more external electronic devices.

31. The method according to claim 30, wherein the interactive mirror is adapted to recognize an external electronic device if it is brought into the vicinity of the mirror and/or switched on in the vicinity of the mirror.

32. The method according to claim 30, wherein the interactive mirror is adapted to perform one or more of the following actions on the basis of the data received from an external electronic device: change from an inactive mode to an active mode, change from an active mode to an inactive mode, start and/or termination of an application related to the external electronic device, indication of device-specific information on the display, indication of instructions on the display, indication of usage data associated with the previous and/or recommended way of use of the external electronic device, control of a further external electronic device, transfer of device-specific information and/or usage data to a further external electronic device.

33. The method according to claim 29, wherein the processor is adapted to identify a person in front of the mirror on the basis of the data captured by the at least one sensor.

34. The method according to claim 33, wherein the processor is adapted to show personalized data on the display on the basis of the identification.

35. The method according to claim 29, wherein the processor is adapted to integrate or show information indicated on the display into or in the mirror image of a person in front of the mirror.
